(19) United States
(12) Patent Application Publication
(10) Pub. No.: US 2017/0277568 A1
(43) Pub. Date: Sep. 28, 2017

(54) ALLOCATING RESOURCES AMONG TASKS UNDER UNCERTAINTY

(71) Applicant: International Business Machines Corporation, Armonk, NY (US)

(72) Inventors: Yingdong Lu, Yorktown Heights, NY (US); Siva Theja Maguluri, Sleepy Hollow, NY (US); Mark S. Squillante, Greenwich, CT (US); Chai Wah Wu, Hopewell Junction, NY (US)

(21) Appl. No.: 15/081,827

(22) Filed: Mar. 25, 2016

(51) Int. Cl. G06F 9/50; G06Q 10/06

(52) U.S. Cl. CPC G06F 9/5027; G06Q 10/067; G06Q 10/06312

(57) ABSTRACT

A model is built of benefit of each of a plurality of computing tasks under uncertainty as a function of computing resources invested in each of the computing tasks, and a model of risk is built of each of the computing tasks under uncertainty as a function of the computing resources invested in each of the computing tasks. Risk of a task allocation is calculated with the risk model, and benefit of a task allocation is calculated with the benefit model. An allocation of the computing resources is found to increase the benefit and manage the risk. The allocation of computing resources is applied to the computing tasks.

### STATEMENT OF GOVERNMENT RIGHTS

Not Applicable.

### CROSS-REFERENCE TO RELATED APPLICATIONS

Not Applicable.

### FIELD OF THE INVENTION

The present invention relates to the electrical, electronic and computer arts, and, more particularly, to analytics, optimization, and the like.

### BACKGROUND OF THE INVENTION

There are a variety of technological environments wherein decision making under uncertainty (DMuU) capability is helpful. One non-limiting example is the management of computer systems, wherein it is appropriate to periodically determine which computing devices to apply cybersecurity and/or other resources to, under many sources of uncertainty.

### SUMMARY OF THE INVENTION

Principles of the invention provide techniques for allocating resources among tasks under uncertainty. In one aspect, an exemplary method to allocate computing resources among computing tasks includes building a model of benefit of each of the computing tasks under uncertainty as a function of computing resources invested in each of the computing tasks; building a model of risk of each of the computing tasks under uncertainty as a function of the computing resources invested in each of the computing tasks; calculating risk of a task allocation with the risk model; calculating benefit of a task allocation with the benefit model; finding an allocation of the computing resources to increase the benefit and manage the risk; and applying the allocation of computing resources to the computing tasks.

As used herein, “facilitating” an action includes performing the action, making the action easier, helping to carry the action out, or causing the action to be performed. Thus, by way of example and not limitation, instructions executing on one processor might facilitate an action carried out by instructions executing on a remote processor, by sending appropriate data or commands to cause or aid the action to be performed. For the avoidance of doubt, where an actor facilitates an action by other than performing the action, the action is nevertheless performed by some entity or combination of entities.

One or more embodiments of the invention or elements thereof can be implemented in the form of a computer program product including a computer readable storage medium with computer usable program code for performing the method steps indicated. Furthermore, one or more embodiments of the invention or elements thereof can be implemented in the form of a system (or apparatus) including a memory, and at least one processor that is coupled to the memory and operative to perform exemplary method steps. Yet further, in another aspect, one or more embodiments of the invention or elements thereof can be implemented in the form of means for carrying out one or more of the method steps described herein; the means can include (i) hardware module(s), (ii) software module(s) stored in a computer readable storage medium (or multiple such media) and implemented on a hardware processor, or (iii) a combination of (i) and (ii); any of (i)-(iii) implement the specific techniques set forth herein.

Techniques of the present invention can provide substantial beneficial technical effects; for example, one or more embodiments provide efficient task and budget allocation in complex systems, for example computer systems and networks. These networks operate with uncertainties in both resources and demand. One or more embodiments quantify the uncertainty, along with the dynamics the systems will follow, and make task allocation decisions over time for any performance criterion a user specifies. One non-limiting example is the allocation of cybersecurity resources; in this aspect, one or more embodiments maximize the effect and coverage with limited cybersecurity resources. Another non-limiting example is energy consumption and computing, wherein allocation techniques in accordance with one or more embodiments provide the best balance between energy consumption and computing, and make the computation most efficient.

These and other features and advantages of the present invention will become apparent from the following detailed description of illustrative embodiments thereof, which is to be read in connection with the accompanying drawings.

### BRIEF DESCRIPTION OF THE DRAWINGS

FIG. 1 depicts a cloud computing node according to an embodiment of the present invention;

FIG. 2 depicts a cloud computing environment according to an embodiment of the present invention;

FIG. 3 depicts abstraction model layers according to an embodiment of the present invention;

FIG. 4 depicts an exemplary system block diagram and flow chart, according to an aspect of the invention;

FIG. 5 depicts another exemplary system block diagram and flow chart, according to an aspect of the invention;

FIGS. 6-8 depict input-output diagrams, according to an aspect of the invention;

FIG. 9 shows an exemplary mathematical model used to allocate computing resources, according to an aspect of the invention; and

FIG. 10 shows plots of tasks for which resources are to be allocated, according to an aspect of the invention.

### DETAILED DESCRIPTION OF PREFERRED EMBODIMENTS

It is understood in advance that although this disclosure includes a detailed description on cloud computing, implementation of the teachings recited herein are not limited to a cloud computing environment. Rather, embodiments of the present invention are capable of being implemented in conjunction with any other type of computing environment now known or later developed.

Cloud computing is a model of service delivery for enabling convenient, on-demand network access to a shared pool of configurable computing resources (e.g. networks, network bandwidth, servers, processing, memory, storage, applications, virtual machines, and services) that can be rapidly provisioned and released with minimal management effort or interaction with a provider of the service. This cloud model may include at least five characteristics, at least three service models, and at least four deployment models.

Characteristics are as follows:

On-demand self-service: a cloud consumer can unilaterally provision computing capabilities, such as server time and network storage, as needed automatically without requiring human interaction with the service's provider.

Broad network access: capabilities are available over a network and accessed through standard mechanisms that promote use by heterogeneous thin or thick client platforms (e.g., mobile phones, laptops, and PDAs).

Resource pooling: the provider's computing resources are pooled to serve multiple consumers using a multi-tenant model, with different physical and virtual resources dynamically assigned and reassigned according to demand. There is a sense of location independence in that the consumer generally has no control or knowledge over the exact location of the provided resources but may be able to specify location at a higher level of abstraction (e.g., country, state, or datacenter).

Rapid elasticity: capabilities can be rapidly and elastically provisioned, in some cases automatically, to quickly scale out and rapidly released to quickly scale in. To the consumer, the capabilities available for provisioning often appear to be unlimited and can be purchased in any quantity at any time.

Measured service: cloud systems automatically control and optimize resource use by leveraging a metering capability at some level of abstraction appropriate to the type of service (e.g., storage, processing, bandwidth, and active user accounts). Resource usage can be monitored, controlled, and reported providing transparency for both the provider and consumer of the utilized service.

Service Models are as follows:

Software as a Service (SaaS): the capability provided to the consumer is to use the provider's applications running on a cloud infrastructure. The applications are accessible from various client devices through a thin client interface such as a web browser (e.g., web-based email). The consumer does not manage or control the underlying cloud infrastructure including network, servers, operating systems, storage, or even individual application capabilities, with the possible exception of limited user-specific application configuration settings.

Platform as a Service (PaaS): the capability provided to the consumer is to deploy onto the cloud infrastructure consumer-created or acquired applications created using programming languages and tools supported by the provider. The consumer does not manage or control the underlying cloud infrastructure including networks, servers, operating systems, or storage, but has control over the deployed applications and possibly application hosting environment configurations.

Infrastructure as a Service (IaaS): the capability provided to the consumer is to provision processing, storage, networks, and other fundamental computing resources where the consumer is able to deploy and run arbitrary software, which can include operating systems and applications. The consumer does not manage or control the underlying cloud infrastructure but has control over operating systems, storage, deployed applications, and possibly limited control of select networking components (e.g., host firewalls).

Deployment Models are as follows:

Private cloud: the cloud infrastructure is operated solely for an organization. It may be managed by the organization or a third party and may exist on-premises or off-premises.

Community cloud: the cloud infrastructure is shared by several organizations and supports a specific community that has shared concerns (e.g., mission, security requirements, policy, and compliance considerations). It may be managed by the organizations or a third party and may exist on-premises or off-premises.

Public cloud: the cloud infrastructure is made available to the general public or a large industry group and is owned by an organization selling cloud services.

Hybrid cloud: the cloud infrastructure is a composition of two or more clouds (private, community, or public) that remain unique entities but are bound together by standardized or proprietary technology that enables data and application portability (e.g., cloud bursting for load balancing between clouds).

A cloud computing environment is service oriented with a focus on statelessness, low coupling, modularity, and semantic interoperability. At the heart of cloud computing is an infrastructure comprising a network of interconnected nodes.

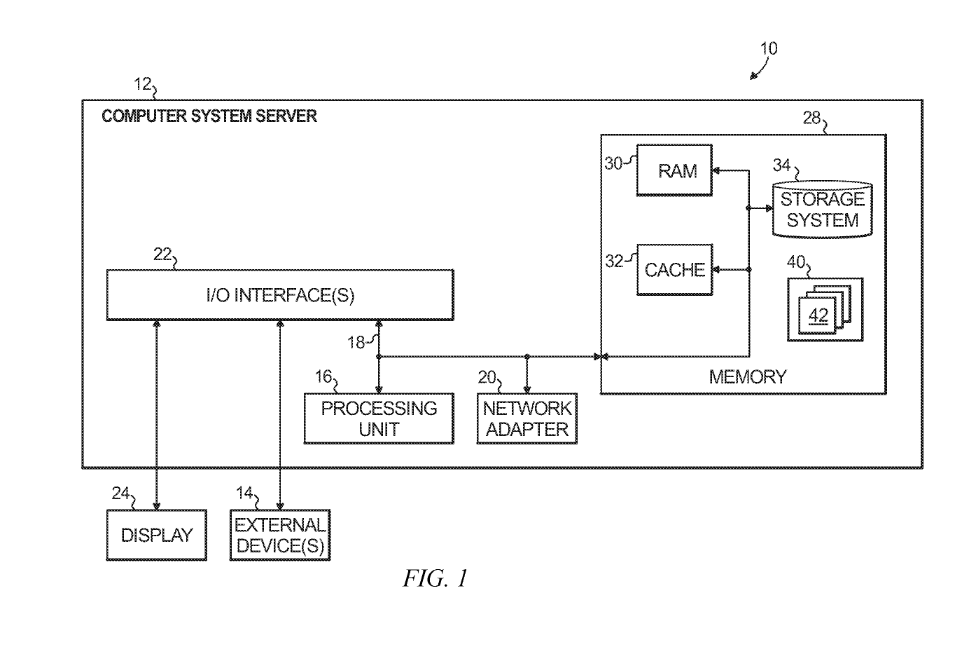

Referring now to FIG. 1, a schematic of an example of a cloud computing node is shown. Cloud computing node 10 is only one example of a suitable cloud computing node and is not intended to suggest any limitation as to the scope of use or functionality of embodiments of the invention described herein. Regardless, cloud computing node 10 is capable of being implemented and/or performing any of the functionality set forth hereinabove.

In cloud computing node 10 there is a computer system/server 12, which is operational with numerous other general purpose or special purpose computing system environments or configurations. Examples of well-known computing systems, environments, and/or configurations that may be suitable for use with computer system/server 12 include, but are not limited to, personal computer systems, server computer systems, thin clients, thick clients, handheld or laptop devices, multiprocessor systems, microprocessor-based systems, set top boxes, programmable consumer electronics, network PCs, minicomputer systems, mainframe computer systems, and distributed cloud computing environments that include any of the above systems or devices, and the like.

Computer system/server 12 may be described in the general context of computer system executable instructions, such as program modules, being executed by a computer system. Generally, program modules may include routines, programs, objects, components, logic, data structures, and so on that perform particular tasks or implement particular abstract data types. Computer system/server 12 may be practiced in distributed cloud computing environments where tasks are performed by remote processing devices that are linked through a communications network. In a distributed cloud computing environment, program modules may be located in both local and remote computer system storage media including memory storage devices.

As shown in FIG. 1, computer system/server 12 in cloud computing node 10 is shown in the form of a general-purpose computing device. The components of computer system/server 12 may include, but are not limited to, one or more processors or processing units 16, a system memory 28, and a bus 18 that couples various system components including system memory 28 to processor 16.

Bus 18 represents one or more of any of several types of bus structures, including a memory bus or memory controller, a peripheral bus, an accelerated graphics port, and a processor or local bus using any of a variety of bus architectures. By way of example, and not limitation, such architectures include Industry Standard Architecture (ISA) bus, Micro Channel Architecture (MCA) bus, Enhanced ISA (EISA) bus, Video Electronics Standards Association (VESA) local bus, and Peripheral Component Interconnect (PCI) bus.

Computer system/server 12 typically includes a variety of computer system readable media. Such media may be any available media that is accessible by computer system/server 12, and it includes both volatile and non-volatile media, removable and non-removable media.

System memory 28 can include computer system readable media in the form of volatile memory, such as random access memory (RAM) 30 and/or cache memory 32. Computer system/server 12 may further include other removable/non-removable, volatile/non-volatile computer system storage media. By way of example only, storage system 34 can be provided for reading from and writing to a non-removable, non-volatile magnetic media (not shown and typically called a “hard drive”). Although not shown, a magnetic disk drive for reading from and writing to a removable, non-volatile magnetic disk (e.g., a “floppy disk”), and an optical disk drive for reading from or writing to a removable, non-volatile optical disk such as a CD-ROM, DVD-ROM or other optical media can be provided. In such instances, each can be connected to bus 18 by one or more data media interfaces. As will be further depicted and described below, memory 28 may include at least one program product having a set (e.g., at least one) of program modules that are configured to carry out the functions of embodiments of the invention.

Program/utility 40, having a set (at least one) of program modules 42, may be stored in memory 28 by way of example, and not limitation, as well as an operating system, one or more application programs, other program modules, and program data. Each of the operating system, one or more application programs, other program modules, and program data or some combination thereof, may include an implementation of a networking environment. Program modules 42 generally carry out the functions and/or methodologies of embodiments of the invention as described herein.

Computer system/server 12 may also communicate with one or more external devices 14 such as a keyboard, a pointing device, a display 24, etc.; one or more devices that enable a user to interact with computer system/server 12; and/or any devices (e.g., network card, modem, etc.) that enable computer system/server 12 to communicate with one or more other computing devices. Such communication can occur via Input/Output (I/O) interfaces 22. Still yet, computer system/server 12 can communicate with one or more networks such as a local area network (LAN), a general wide area network (WAN), and/or a public network (e.g., the Internet) via network adapter 20. As depicted, network adapter 20 communicates with the other components of computer system/server 12 via bus 18. It should be understood that although not shown, other hardware and/or software components could be used in conjunction with computer system/server 12. Examples, include, but are not limited to: microcode, device drivers, redundant processing units, and external disk drive arrays, RAID systems, tape drives, and data archival storage systems, etc.

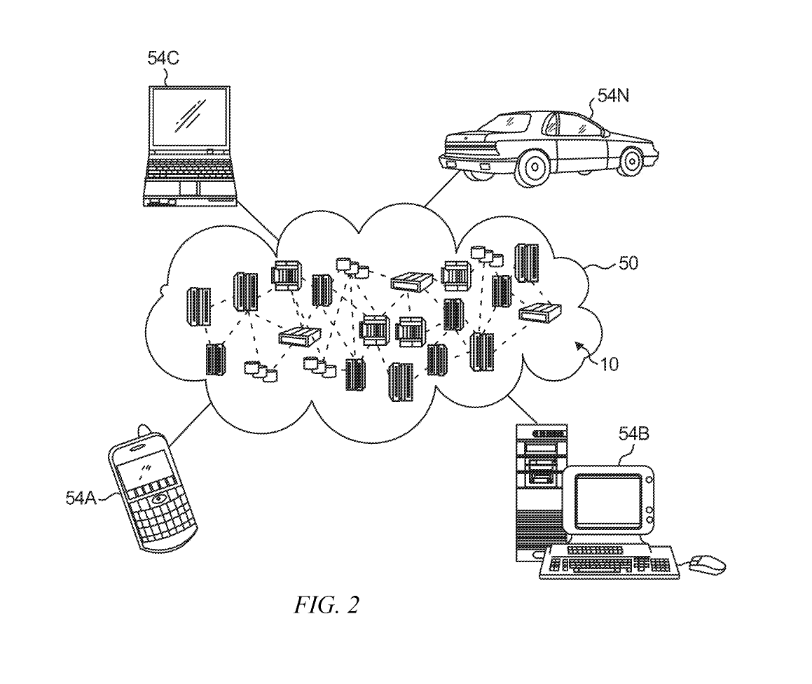

Referring now to FIG. 2, illustrative cloud computing environment 50 is depicted. As shown, cloud computing environment 50 comprises one or more cloud computing nodes 10 with which local computing devices used by cloud consumers, such as, for example, personal digital assistant (PDA) or cellular telephone 54A, desktop computer 54B, laptop computer 54C, and/or automobile computer system 54N may communicate. Nodes 10 may communicate with one another. They may be grouped (not shown) physically or virtually, in one or more networks, such as Private, Community, Public, or Hybrid clouds as described hereinabove, or a combination thereof. This allows cloud computing environment 50 to offer infrastructure, platforms and/or software as services for which a cloud consumer does not need to maintain resources on a local computing device. It is understood that the types of computing devices 54A-N shown in FIG. 2 are intended to be illustrative only and that computing nodes 10 and cloud computing environment 50 can communicate with any type of computerized device over any type of network and/or network addressable connection (e.g., using a web browser).

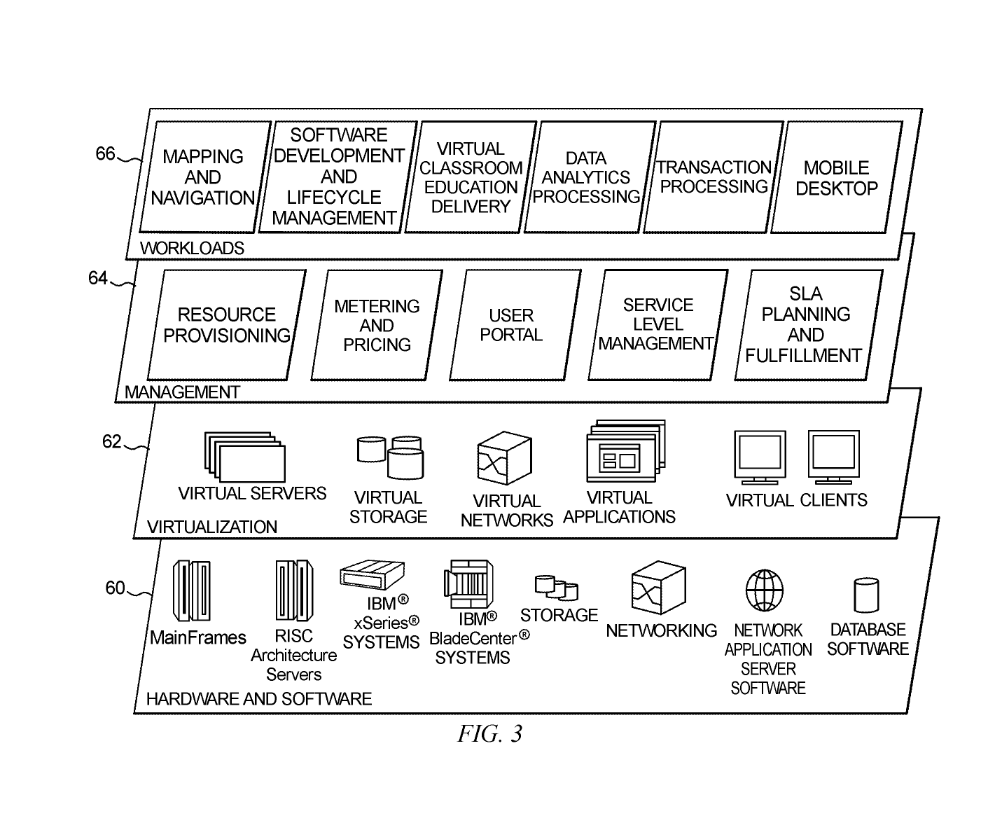

Referring now to FIG. 3, a set of functional abstraction layers provided by cloud computing environment 50 (FIG. 2) is shown. It should be understood in advance that the components, layers, and functions shown in FIG. 3 are intended to be illustrative only and embodiments of the invention are not limited thereto. As depicted, the following layers and corresponding functions are provided:

Hardware and software layer 60 includes hardware and software components. Examples of hardware components include mainframes, in one example IBM® zSeries® systems; RISC (Reduced Instruction Set Computer) architecture based servers, in one example IBM pSeries® systems; IBM xSeries® systems; IBM BladeCenter® systems; storage devices; networks and networking components. Examples of software components include network application server software, in one example IBM Web Sphere® application server software; and database software, in one example IBM DB2® database software. (IBM, zSeries, pSeries, xSeries, BladeCenter, WebSphere, and DB2 are trademarks of International Business Machines Corporation registered in many jurisdictions worldwide).

Virtualization layer 62 provides an abstraction layer from which the following examples of virtual entities may be provided: virtual servers; virtual storage; virtual networks, including virtual private networks; virtual applications and operating systems; and virtual clients.

In one example, management layer 64 may provide the functions described below. Resource provisioning provides dynamic procurement of computing resources and other resources that are utilized to perform tasks within the cloud computing environment. Metering and Pricing provide cost tracking as resources are utilized within the cloud computing environment, and billing or invoicing for consumption of these resources. In one example, these resources may comprise application software licenses. Security provides identity verification for cloud consumers and tasks, as well as protection for data and other resources. User portal provides access to the cloud computing environment for consumers and system administrators. Service level management provides cloud computing resource allocation and management such that required service levels are met. Service Level Agreement (SLA) planning and fulfillment provides pre-arrangement for, and procurement of, cloud computing resources for which a future requirement is anticipated in accordance with an SLA.

Workloads layer 66 provides examples of functionality for which the cloud computing environment may be utilized. Examples of workloads and functions which may be provided from this layer include: mapping and navigation; software development and lifecycle management; virtual classroom education delivery; data analytics processing; transaction processing; and mobile desktop.

As noted, there are a variety of technological environments wherein decision making under uncertainty (DMuU) capability is helpful. One non-limiting example is the management of computer systems, wherein it is appropriate to periodically determine which computing devices to apply cybersecurity and/or other resources to, under many sources of uncertainty. Currently, there are no decision making under uncertainty (DMuU) capabilities and limited data analytics. Consider the problem of portfolio optimization under uncertainty (a portfolio in this sense referring to computing resources rather than financial instruments). Data centers have many different computing devices which are managed from the reliability, performance, and security perspectives. Currently, little or no data analytics are employed to determine the best possible portfolio of computer management decisions. One or more embodiments advantageously use data analytics to build predictive models for each computing device across the dimensions of reliability, performance, security, risk, and financials. One or more embodiments employ DMuU portfolio optimization solutions on top of predictive models with differing return-on-investment (ROI), both one-time and over time.

Consider also the problem of budget and/or resource optimization under uncertainty. Data centers also need to determine the allocation of financial budgets and resources across cybersecurity and other computer management options. Currently, there is little or no data analytics used to determine best possible portfolio of budgets and/or resources among computing devices. One or more embodiments employ DMuU budget and/or resource optimization solutions on top of predictive models with differing ROI and time scales.

One or more embodiments provide decision making under uncertainty solutions that jointly address both of the aforementioned problems.

Another non-limiting exemplary application is in the pharmaceutical field, wherein companies need to periodically determine a portfolio of projects and trial stages under many sources of uncertainty. Here again, there is currently no decision making under uncertainty (DMuU) capability and limited data analytics. Regarding portfolio optimization under uncertainty in this context, a pharmaceutical company may have many different research projects in different stages of development and trials. Currently, a form of data analytics may be used to predict a “score” for each project across various dimensions of performance and risk. Then, a committee decides what projects to continue, to advance to the next stage, to introduce, and to eliminate. One or more embodiments advantageously provide DMuU portfolio optimization solutions on top of predictive “score” models with differing ROI, one-time and over time.

In the pharmaceutical field, problems of budget and/or resource optimization under uncertainty also arise. A pharmaceutical company typically also needs to determine an allocation of financial budgets across areas and of resources across research projects. Today this is done by the same committee deciding what projects to continue, advance, introduce and eliminate. One or more embodiments advantageously provide DMuU budget and/or resource optimization solutions on top of predictive “score” models with differing ROI and time scales.

Once again, one or more embodiments provide decision making under uncertainty solutions that jointly address both of the aforementioned problems.

One or more embodiments advantageously identify a connection between cybersecurity decisions or stages of development and/or trials and financial instruments. Even though cybersecurity decisions (such as applying a security patch) are very different from traditional financial instruments (such as stocks and/or options), one or more embodiments leverage concepts from financial math and/or engineering (such as risk measures). One or more embodiments model uncertainties around cybersecurity decisions by capturing their key characteristics from a reliability, performance, security, and financial perspective. A richer modeling of uncertainty for cybersecurity decisions or different stages of development and/or trials is provided in one or more embodiments. At best, the current industry standard is to use machine learning algorithms to obtain a score. One or more embodiments employ machine learning and statistical inference to infer the probability distribution of revenue, risk, cost and efficacy, i.e., to infer a probabilistic characterization of a non-traditional financial instrument.

One or more embodiments support both one-time optimization and optimization over time. Regarding one-time optimization, the current industry standard is to select based on scores. One or more embodiments instead optimize an objective which, for example, is expected return. Regarding optimization over time, the current industry standard does not provide this capability. Currently, in the financial math literature, benefit or risk are optimized at the end of a period of time. One or more embodiments instead optimize an objective which, for example, is a weighted sum of expected return over time.

Many other applications are possible. For example, a business division needs to allocate its budget among different investments such as development, sales, marketing, etc. One or more embodiments also include the notion of a preference profile when calculating benefits, to take into account the time scale of financials, performance, risks, and so on. Preference profile is, for example, the weight an executive assigns to benefit for each time period. For example, some executives prefer long term revenue even at the cost of short term and some executives may prefer short term revenue at the expense of long term. In another aspect, a company needs to decide which set of products to offer and how to allocate resources (e.g., budget, personnel, etc.) among these product offerings.

Even in the cybersecurity and pharmaceutical examples, the preference profile can play a valuable role.

One or more embodiments advantageously solve the resource allocation under uncertainty problem by first modeling the uncertainty of tasks to characterize their benefits and risks over time. Then, measures of the benefit and risk are computed over time and weighted according to a preference profile. This information is then used by a stochastic method to find a task allocation that increases the benefit while managing risk. The tasks are then allocated according to the output of the method. Task allocations are determined both at the start of the time horizon and adaptively adjusted over time as uncertainty is realized.

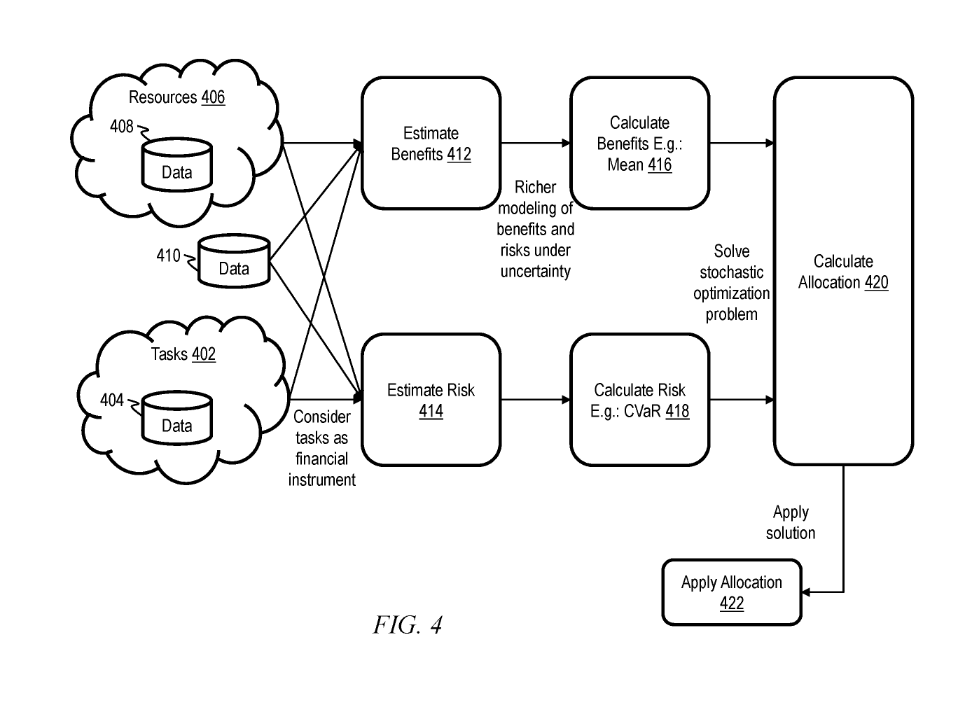

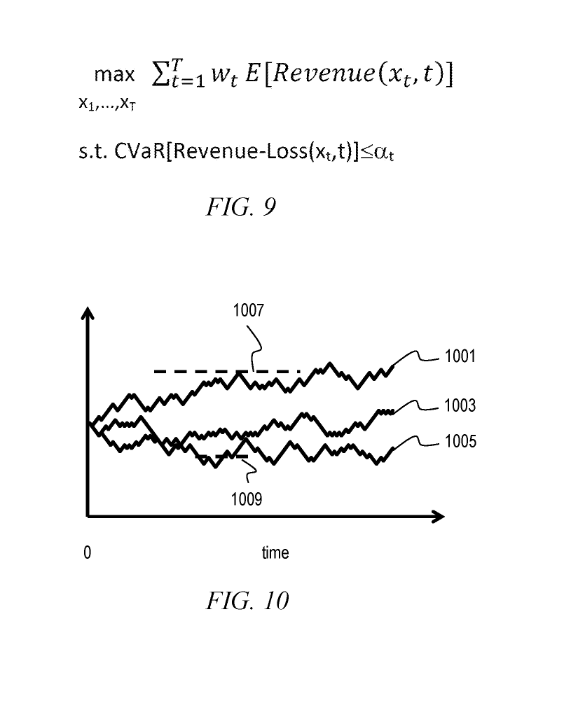

Referring now to FIG. 4, certain tasks 402 characterized by data 404 need to be performed. Resources 406 characterized by data 408 are available to carry out the tasks. Other data 410 is also available for decision-making input, in some circumstances. Treating the tasks as a financial instrument, the benefits of proceeding in a certain way are estimated at 412, while the risks are estimated at 414. Referring to FIGS. 9 and 10, tasks are treated as financial instruments in the sense that the uncertainty of return on investment around any task relative to demand for the task is modeled as a financial instrument, where increasing investment in a task can go up as demand for the task goes up. On the other hand, return on the investment in a task can go down if the position of investment in the task is higher than the demand for the task. In addition, this modeling of a task is as a non-traditional financial instrument in the sense that increasing investment in a task when demand for the task rises may not increase linearly with the investment, whereas the return on investment in a traditional financial instrument increases essentially linearly with the rising value of the instrument. Data can be used to infer possibly time-dependent probabilistic characterizations of such nontraditional financial instruments for tasks.

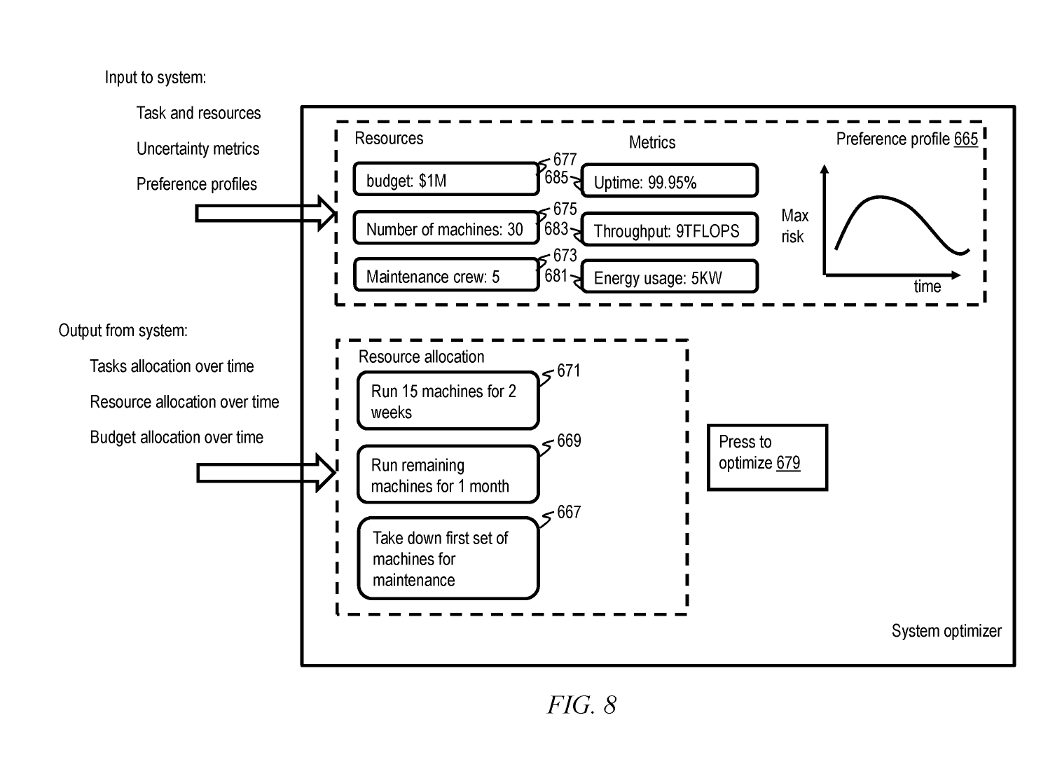

Benefits and risks can be functionals (used in this context as functions of functions) of revenue, costs and performance, each of which is uncertain. One of several measures of benefit can be mean revenue and/or cost or probability of revenue and/or cost exceeding a certain value, as seen at 416. One of several measures of risk can be variance, Value-at-Risk (VaR), Conditional Value at Risk (CVaR), or the like, as seen at 418. Benefit and risk can be calculated in one snapshot or over a period of time, optionally including a preference profile as illustrated at 665 of FIG. 8. Referring to FIGS. 9 and 10, the preference profile provides the ability to weight the importance of the return on investments with respect to time. As an illustrative example, not restricting the idea of preference profile, one can put greater importance on returns on investments in the short term or greater importance on returns on investments in the long term or any options in between. Allocation can be calculated at 420 using tools such as stochastic optimization. The allocation is applied at 422. Richer modeling of benefits and risks under uncertainty is thus provided, as compared to prior art techniques.

In FIG. 10, the three plots 1001, 1003, 1005 are three tasks that are candidates for investment. At t=0, come up with a strategy about how much to invest in each. Over time (horizontal axis), the uncertainties and risks are revealed. The boundary lines 1007, 1009 show that it is not only determined how much to invest at t=0, but also as time goes on. For example, if plot 1001 exceeds a certain threshold 1007, invest more. If plot 1005 falls below a certain threshold 1009, invest less (sell assets or terminate the project). This illustrates the concept that there is an initial decision up front that the optimization provides, and then there is an adaptive component such that, as things are being realized, one can invest more or less; terminate; add a new task, and the like.

Furthermore regarding preference profile, an executive may be more concerned about long-term profits or rewards, and so may wish to weight long-term results more heavily. Conversely, an executive may be more concerned about short-term profits or rewards, and so may wish to weight short-term results more heavily. In financial modelling, normally only the value at the end time is of interest (e.g., retirement time for a 401K account). In one or more embodiments, it is possible to weight the rewards over time in a different manner.

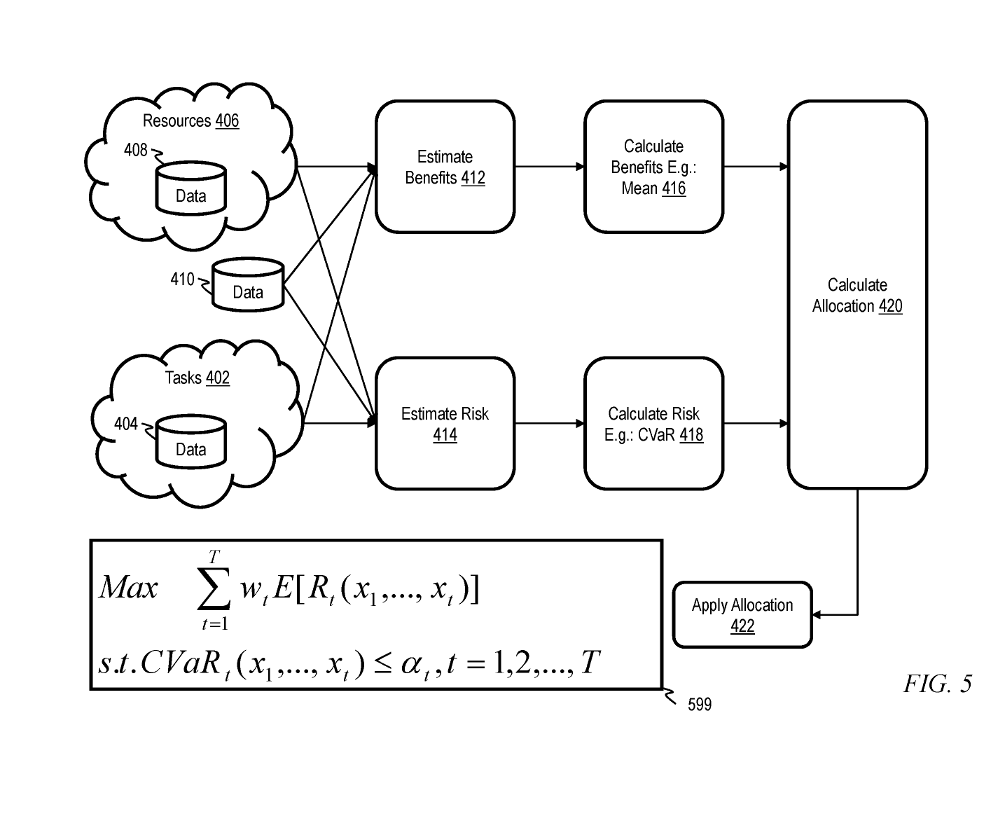

Referring to FIG. 5, wherein like reference characters refer to like elements, consider, as at 599, a resource allocation approach wherein:
xₜ=allocation decision at time t
Rₜ(x₁,x₂, . . . ,xₜ)=Benefit function at time t
CVaRₜ(x₁,x₂, . . . ,xₜ)=risk measure at time t
aₜ=risk tolerance level at time t

FIG. 9 shows an alternative formulation.

As seen at 599, the summation is maximized such that the risk CVaRₜ does not exceed the risk tolerance level at any time of interest.

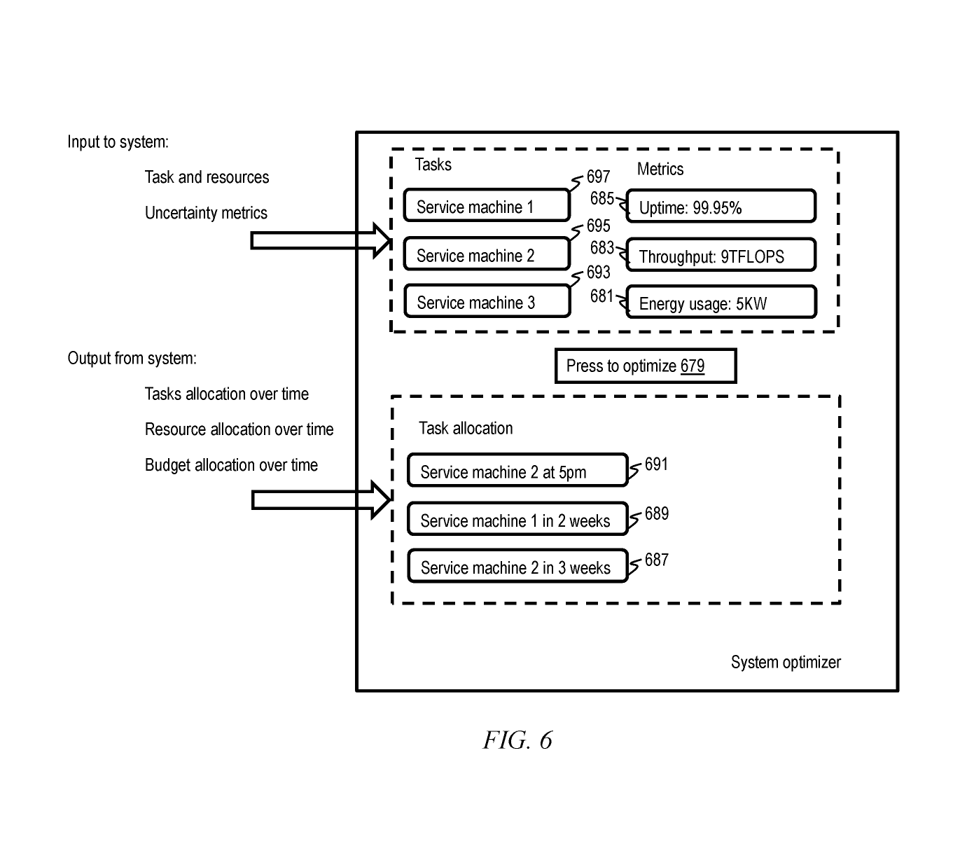

As seen in FIG. 6, in one or more embodiments, inputs to the system include tasks and resources, and uncertainty metrics. In this non-limiting example, the tasks 697, 695, 693 include servicing machines 1, 2, and 3; while the metrics include an uptime of 99.95% as at 685, throughput of 9 Teraflops as at 683, and energy usage of 5 kW as at 681. Furthermore, the output from the system includes allocation of tasks over time and budget allocation over time. In this non-limiting example, the allocation of tasks over time 691, 689, 687 include servicing machine 2 at 5 PM; servicing machine 1 in two weeks; and servicing machine 2 in three weeks. FIG. 6 also represents an exemplary screen shot of a system optimizer wherein the user may press or click a “press to optimize” button 679 to initiate the optimization process.

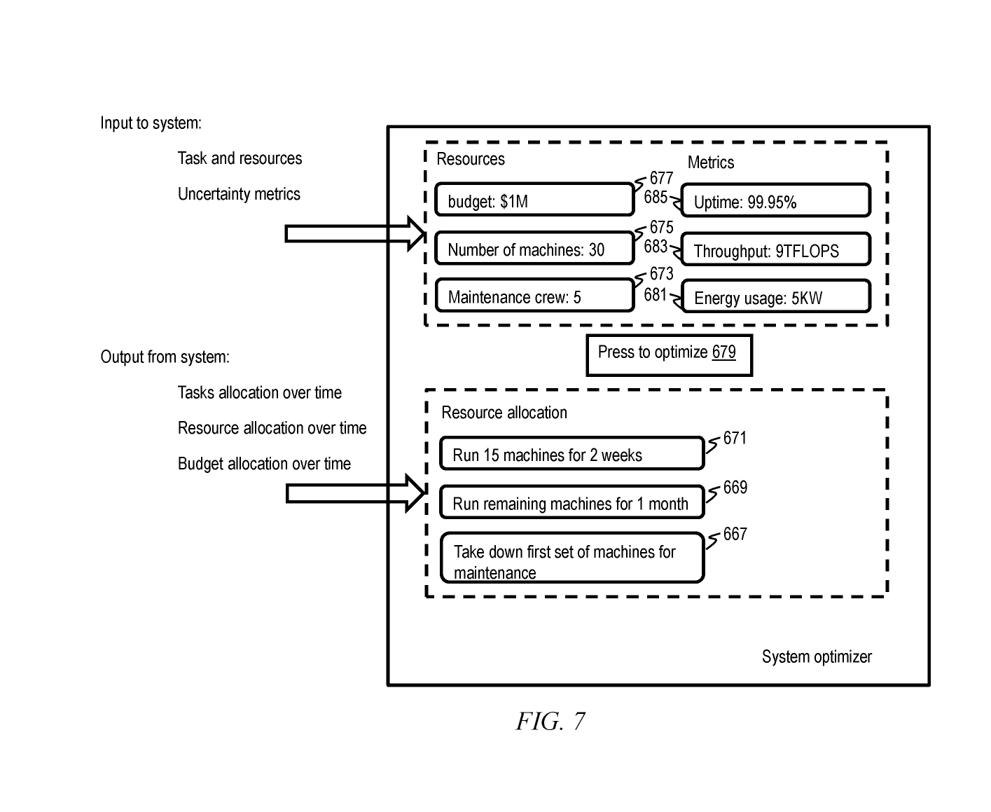

As seen in FIG. 7, in one or more embodiments, inputs to the system include tasks and resources, and uncertainty metrics. In this non-limiting example, the resources 677, 675, 673 include a budget of $1,000,000; 30 machines; and a maintenance crew of five; while the metrics include an uptime of 99.95% as at 685, throughput of 9 Teraflops as at 683, and energy usage of 5 kW as at 681. Furthermore, the output from the system includes allocation of resources among tasks over time and budget allocation over time. In this non-limiting example, the allocation of resources over time 671, 669, 667 includes running 15 machines for two weeks; running the remaining machines for one month; and taking down the first set of machines for maintenance. FIG. 7 also represents an exemplary screen shot of the system optimizer wherein the user may press or click the “press to optimize” button 679 to initiate the optimization process.

As seen in FIG. 8, in one or more embodiments, inputs to the system include tasks and resources, uncertainty metrics, and preference profiles. In this non-limiting example, the resources 677, 675, 673 include a budget of $1,000,000; 30 machines; and a maintenance crew of five; the metrics include an uptime of 99.95% as at 685, throughput of 9 Teraflops as at 683, and energy usage of 5 kW as at 681; and the preference profile includes maximum tolerable risk as a function of time, as seen at 665. Furthermore, the output from the system includes allocation of resources among tasks over time and budget allocation over time. In this non-limiting example, the allocation of resources over time 671, 669, 667 includes running 15 machines for two weeks; running the remaining machines for one month; and taking down the first set of machines for maintenance. FIG. 7 also represents an exemplary screen shot of the system optimizer wherein the user may press or click the “press to optimize” button 679 to initiate the optimization process.

One or more embodiments thus provide a method to allocate resources among tasks to increase the benefit while managing risk. Steps include estimating the benefit of each task under uncertainty as a function of resources invested in each of the tasks; estimating the risk of each task under uncertainty as a function of resources invested in each of the tasks; calculating the risk of a task allocation; calculating the benefit of a task allocation; finding an allocation of resources to increase benefit and manage risk; and applying the allocation of resources to the tasks.

In one non-limiting exemplary embodiment, estimate the benefit and risk of each experiment; and find an allocation of resources to maximize benefit while minimizing risk (in this regard, allocation can sometimes be binary, i.e., whether or not to continue an experiment).

One or more embodiments thus provide a novel method to allocate resources under uncertainty to increase the benefit while managing risk. One or more embodiments solve this resource allocation under uncertainty problem by first modeling the uncertainty of tasks to characterize their benefits and risks over time. In the prior art, the benefit or risk is determined at the end of the period of interest. In contrast, in one or more embodiments, the benefit and risk are determined over a time period and weighting over time is used to determine the benefit or risk to optimize over.

One or more embodiments thus solve the resource allocation problem by computing the benefit and risk over time and weighting them according to a preference profile. This information is then used by a stochastic program to find a task allocation that increases the benefit while managing risk. The tasks are then allocated according to the output of the optimization program. Benefit can be, for example, mean revenue or a function of mean revenue or the probability that the revenue exceeds a certain value. One of several measures of risk can be used, such as variance, Value-at-Risk (VaR), Conditional Value at Risk (CVaR), and the like. There are known techniques in the prior art for computing VaR, CVAR, etc. Given the teachings herein, the skilled artisan will be able to select appropriate known techniques for computing VaR, CVAR, etc., in order to implement one or more embodiments of the invention.

As noted, benefit and risk can be calculated one-shot or over a period of time, optionally including a preference profile. Allocation can be calculated using tools such as stochastic optimization.

For one-time resource allocation:
x=allocation decision
R(x)=Benefit function
Cvar(x)=risk measure
α=risk tolerance level.

One or more embodiments maximize E[R(x)] such that CVar(x)≦α.

Resource allocation over time is discussed above with respect to element 599 of FIG. 5.

One or more embodiments, unlike prior art techniques, provide mapping of resources, tasks, projects and/or components to financial instruments and/or a preference profile, thus leading to novel optimization methods described herein. Note that mapping of physical resources to financial instruments is not obvious because such resources are not financial instruments (e.g. return on investment for a financial instrument is linear to the value invested, whereas this relationship can be more complex or nonlinear for a general resource). Optimization methods in financial mathematics cannot be applied to physical resource allocation.

One or more embodiments thus provide a method to allocate resources among tasks in order to increase the benefit while at the same time managing risks. An exemplary method includes the following steps:
Estimating with a statistical model the benefit of each task under uncertainty as a function of resources invested in each of the tasks
Estimating with a statistical model the risk of each task under uncertainty as a function of resources invested in each of the tasks
Calculating the risk of a task allocation based on the model
Calculating the benefit of a task allocation based on the model
Using a stochastic optimization method to find an allocation of resources to increase benefit and manage risk
Applying the resulting allocation of resources to the tasks.

Indeed, one or more embodiments reduce the impact of risks/uncertainty for problem areas with high degrees of revenue volatility and large relative investments and will generate significant financial benefits (finance used as analog for physical parameters). New mathematical models and/or methods for disruptive decision making under uncertainty solutions make a connection between tasks and financial instruments. One or more embodiments provide richer modeling of uncertainty for different stages of task development, with decision making under uncertainty optimization at start of time horizon, and adaptive decision making under uncertainty optimization over time. Considering that financial math/engineering literature optimizes terminal value, maximize the weighted sum of revenue subject to CVaR of loss, and note that in one or more embodiments, preference profile captures importance weighting with respect to time.

Thus, one or more embodiments model the uncertainty around task as a financial instrument. Data can be used to infer a set of probabilistic characterizations of nontraditional financial instruments (e.g., return on investment can decrease as investment increases even if financial instrument value rises). Probabilistic characterizations can be time dependent. Mathematical models of uncertainty are used as input to decision making under uncertainty optimization. Initial decision making uncertainty optimization is conducted at the start of the horizon, with adaptive decision making under uncertainty optimization over time.

In the mathematical modeling of uncertainty, one or more embodiments prove convexity/concavity of objectives/constraints; prove the optimal policy to be of a threshold type, and/or derive explicit characterization of optimal thresholds.

Given the discussion thus far, it will be appreciated that, in general terms, an exemplary method to allocate resources among tasks includes the step 412 of building a model of benefit of each of the tasks 402 under uncertainty as a function of resources 406 invested in each of the tasks. A further step 414 includes building a model of risk of each of the tasks 402 under uncertainty as a function of the resources 406 invested in each of the tasks. Further steps include calculating risk of a task allocation with the risk model as at 418, calculating benefit of a task allocation with the benefit model, as at 416, and finding an allocation of the resources to increase the benefit and manage the risk, as at 420. A distinction should be made between step 412 and 416, and between step 414 and 418. Estimation of benefits and risks refers to the question of how to model the tasks as financial instruments. For example, tasks in cybersecurity are modeled as stocks—for estimation, given the data about that entity, consider how to model it as a financial instrument, in terms of risks and rewards. The calculation steps 416, 418 relate to, given the model of the benefits and risks of this task as a financial instrument (developed at 412, 414), how to now calculate those benefits. That is to say, aspects relate to how to characterize or quantify benefits and risks. Thus, steps 412 and 414 are basically about building the models, i.e., what mathematical models from the financial world will be used for this physical problem. Steps 416 and 418 use the selected models to calculate the benefits and the risks.

Note that in many cases, the existing financial models cannot be used as-is. If one invests in a stock and it goes up, the amount of money made is linear in how much is invested in that stock. However, if there is a task and one looks at adding more resources to the task, growth may not be linear—for example, too many people may get in each other's way. Thus, the models differ from financial models in significant ways.

An even further step 422 includes applying the allocation of resources to the tasks.

In one or more embodiments, the steps are carried out using particular software modules executing on a general purpose computer. Applying the allocation depends on what kinds of resources are being allocated. If the same are computing resources, in some instances, a cloud controller (e.g., in management layer 64) allocates the resources. As far as forming models and calculating risks and benefits, non-limiting examples include use of languages such as Python or R to parameterize the model, depending on what model is chosen. Appropriate models will depend, for example, of whether the resource allocation pertains to cybersecurity, cloud resource allocation, or pharma.

Non-limiting cybersecurity example: The physical problem of cybersecurity resource allocation can be analogized to portfolio optimization under uncertainty. For each computing device and data about the device, environment, potential attacks, etc., use a statistical package (e.g., SPSS) to develop a probabilistic model of risk (e.g., Monte Carlo simulation) of impact to reliability, performance, content privacy, etc. This probabilistic model is then mapped to a corresponding financial instrument model (e.g., distribution of return on investment). For example, map output of the Monte Carlo simulations into the distribution of interest using a standard tool such as MATLAB. Use a financial instrument model to calculate measures of interest (e.g., expected return on investment (ROI), CVaR of ROI loss). In one or more embodiments, such calculations can be implemented in a standard programming language such as C. Based on measures of interest for each computing device, determine the optimal portfolio of computer management decisions with respect to a cybersecurity attack. For example, compute the optimal solution using a standard stochastic programming solver such as BNBS, DDSIP, SD (via NEOS), or the like. Portfolio decisions can determine which devices are managed and/or how much management and/or investment to apply. Apply the optimal portfolio decisions to all computing devices involved. For example, generate and/or act upon a list of software packages (e.g., Symantec Endpoint Protection) to be installed on a subset of the computing devices.

Non-limiting pharma project example: The physical problem of pharmaceutical project selection can be analogized to portfolio optimization under uncertainty. For each research project in different stages of development and/or trials and data about the projects, marketing conditions, competitor activities, etc., use a combination of biostatistical and classical statistical methods (e.g., R) to develop a probabilistic model of performance, financials, risks, etc. associated with each project. This probabilistic model is then mapped to a corresponding financial instrument model (e.g., joint distribution of efficacy, risk of side effects and return on investment). For example, map the output of the statistical models into the joint distribution of interest using standard tools such as SPSS. Use a financial instrument model to calculate measures of interest (e.g., expectation and CVaR of joint distribution). In one or more embodiments, such calculations can be implemented in a standard programming language such as C. Based on measures of interest for each project, determine an optimal portfolio of projects. For example, compute the optimal solution using a standard stochastic programming solver such as DECIS. Portfolio decisions can determine which projects are to be pursued and the level of investments in each project. Apply the optimal portfolio decisions to all projects involved. In one or more embodiments, generate and/or act upon a list of financial and resource investments to be pursued for a selected subset of projects.

Non-limiting cloud resource allocation example: The physical problem of cloud computing resource allocation can be analogized to portfolio optimization under uncertainty. For each cloud resource and data about the resource, environment, future demand, energy usage, etc., use a statistical package (e.g., SPSS) to develop probabilistic models (e.g., Monte Carlo simulation) of the ability to drive revenues, reduce costs, reduce SLA (service level agreements) violations, etc. These probabilistic models are then mapped to corresponding financial instrument models (e.g., joint distribution of return on investment and customer satisfaction). For example, map the output of the Monte Carlo simulations into the joint distribution of interest using standard tools such as R. Use the financial instrument model to calculate measures of interest (e.g., expectation and CVaR of joint distribution). In one or more embodiments, such calculations can be implemented in a standard programming language such as C. Based on measures of interest for each cloud resource, determine optimal portfolio of cloud resource management with respect to satisfying demand and SLAs and maximizing return on investment. For example, compute an optimal solution using a standard stochastic programming solver such as COIN-OR Stochastic Modeling Interface (SMI). Portfolio decisions can determine which resources are managed and/or how much management/investment to apply. Apply the optimal portfolio decisions to all cloud resources involved. For example, generate and/or act upon a list of energy-aware scheduling policies, capacity planning of cloud resources, allocation of applications to different resources, etc. Resources can be allocated, for example, to a tenant or a particular workload of a tenant.

In some cases, the model building and calculating steps are carried out for a single point in time, while in other cases, the model building and calculating steps are carried out over time and weighted according to a preference profile such as 665.

In some cases, the step of finding the allocation comprises using a stochastic program. The skilled artisan will appreciate that, in the field of mathematical optimization, stochastic programming is a framework for modeling optimization problems that involve uncertainty. Given the teachings herein, the skilled artisan will be able to select and adapt known stochastic programming solvers, such as FortSP, NEOS Solvers (Bouncing Nested Benders Solvers (BNBS) for multi-stage stochastic linear programs, ddsip for two-stage stochastic programs with integer recourse, and Stochastic Decomposition (SD) for two-stage stochastic linear programs), QUASAR, COIN-OR Stochastic Modeling Interface, Stochastic Minizinc, or the like.

As noted, the benefit could be mean (i.e. average expected) revenue; a function of mean revenue; or a probability of revenue exceeding a certain value.

Assume there is a random variable for revenue, being added up over time. Referring to FIG. 9, maximize wₜ (weight—preference profile); this is expected revenue based on the decisions made at time t—that is the expected or average revenue. In the constraints, subject to CVaR—tail probability—make sure that probability of revenue loss is kept very low. The objective could be, for example, average or expected or mean revenue, some tail probability, or the like. For example, consider a case wherein one investment option gives 100 million plus or minus 5 million while the other gives 100 million plus or minus 200 million. In the latter case, positive side is very high but negative side is very low. It may be desirable to focus on not losing money (or the analog of same in the physical world).

As noted, the risk could be value-at-risk (VaR) or conditional value at risk (CVaR). As used herein, Value at Risk (VaR) is a measure of the risk of investments. It estimates how much a set of investments might lose, given normal market conditions, in a set time period such as a day. Furthermore, as used herein, Conditional Value at Risk (CVaR), also called Average Value at Risk (AVaR), expected tail loss (ETL), or Expected shortfall (ES) is a risk measure—a concept used in the field of financial risk measurement to evaluate the market risk or credit risk of a portfolio. The “expected shortfall at q % level” is the expected return on the portfolio in the worst q % of cases. ES is an alternative to Value at Risk that is more sensitive to the shape of the loss distribution in the tail of the distribution.

In some cases, the resources comprise computing resources, and the tasks comprise computing tasks. In some such cases, the computing resources comprise cloud computing resources, the computing tasks comprise cloud computing tasks, and the applying step comprises controlling allocation of the cloud computing resources with a cloud management layer. In other such cases, the computing resources comprise cybersecurity computing resources, the computing tasks comprise cybersecurity computing tasks, and the applying step comprises controlling installation of a plurality of cybersecurity software packages on a subset of a set of managed computing devices.

The cloud computing resources in FIG. 3 are a non-limiting example of computer resources that could be allocated in accordance with one or more embodiments. In the example of FIG. 6, output is a maintenance schedule; i.e., when to take down the particular machines. In the example of FIG. 7, output is workload balancing—how should the workload be deployed on the machine. In the example of FIG. 8, output is similar to FIG. 7 but with a preference profile that guides the optimization appropriately.

In a “pharma planning” example, imagine running a pharmaceutical company and having projects or trials progressing through a pipeline—early experiments, animal experiments, limited experiments on humans, larger experiments on humans, and so on. Once a year, e.g., executives sit down and decide what projects to terminate, what new projects to introduce, and/or where to invest more or less resources. Currently, statisticians develop scores for each project and humans manually looking at scores decide what to do. Statisticians have developed much richer information about those projects than just the scores. One or more embodiments use this richer information (and/or the raw data used to develop it) and develop richer models of the projects (existing ones and new ones that might be added), which are treated as financial instruments. New capability decides which to terminate, which to advance forward, which new ones to add, and in each case, how much to invest (e.g., more resources to highly promising project, less resources to project with uncertain results). See FIG. 10. In addition to making that decision at the beginning of the year, one or more embodiments provide information wherein if a particular project drops below a certain threshold, it can be terminated and a new project introduced; if a particular project exceeds a certain threshold, invest more.

One or more embodiments of the invention, or elements thereof, can be implemented in the form of an apparatus including a memory and at least one processor that is coupled to the memory and operative to perform exemplary method steps.

One or more embodiments can make use of software running on a general purpose computer or workstation. With reference to FIG. 1, such an implementation might employ, for example, a processor 16, a memory 28, and an input/output interface 22 to a display 24 and external device(s) 14 such as a keyboard, a pointing device, or the like. The term “processor” as used herein is intended to include any processing device, such as, for example, one that includes a CPU (central processing unit) and/or other forms of processing circuitry. Further, the term “processor” may refer to more than one individual processor. The term “memory” is intended to include memory associated with a processor or CPU, such as, for example, RAM (random access memory) 30, ROM (read only memory), a fixed memory device (for example, hard drive 34), a removable memory device (for example, diskette), a flash memory and the like. In addition, the phrase “input/output interface” as used herein, is intended to contemplate an interface to, for example, one or more mechanisms for inputting data to the processing unit (for example, mouse), and one or more mechanisms for providing results associated with the processing unit (for example, printer). The processor 16, memory 28, and input/output interface 22 can be interconnected, for example, via bus 18 as part of a data processing unit 12. Suitable interconnections, for example via bus 18, can also be provided to a network interface 20, such as a network card, which can be provided to interface with a computer network, and to a media interface, such as a diskette or CD-ROM drive, which can be provided to interface with suitable media.

Accordingly, computer software including instructions or code for performing the methodologies of the invention, as described herein, may be stored in one or more of the associated memory devices (for example, ROM, fixed or removable memory) and, when ready to be utilized, loaded in part or in whole (for example, into RAM) and implemented by a CPU. Such software could include, but is not limited to, firmware, resident software, microcode, and the like.

A data processing system suitable for storing and/or executing program code will include at least one processor 16 coupled directly or indirectly to memory elements 28 through a system bus 18. The memory elements can include local memory employed during actual implementation of the program code, bulk storage, and cache memories 32 which provide temporary storage of at least some program code in order to reduce the number of times code must be retrieved from bulk storage during implementation.

Input/output or I/O devices (including but not limited to keyboards, displays, pointing devices, and the like) can be coupled to the system either directly or through intervening I/O controllers.

Network adapters 20 may also be coupled to the system to enable the data processing system to become coupled to other data processing systems or remote printers or storage devices through intervening private or public networks. Modems, cable modem and Ethernet cards are just a few of the currently available types of network adapters.

As used herein, including the claims, a “server” includes a physical data processing system (for example, system 12 as shown in FIG. 1) running a server program. It will be understood that such a physical server may or may not include a display and keyboard.

One or more embodiments are particularly significant in the context of a cloud or virtual machine environment, although this is exemplary and non-limiting. Reference is made back to FIGS. 1-3 and accompanying text.

It should be noted that any of the methods described herein can include an additional step of providing a system comprising distinct software modules embodied on a computer readable storage medium; the modules can include, for example, any or all of the appropriate elements depicted in the block diagrams and/or described herein; by way of example and not limitation, any one, some or all of the modules/blocks and or sub-modules/sub-blocks shown in the figures and/or disclosed and described herein.

The method steps can then be carried out using the distinct software modules and/or sub-modules of the system, as described above, executing on one or more hardware processors such as 16. Further, a computer program product can include a computer-readable storage medium with code adapted to be implemented to carry out one or more method steps described herein, including the provision of the system with the distinct software modules.

One example of user interface is hypertext markup language (HTML) code served out by a server or the like, to a browser of a computing device of a user. The HTML is parsed by the browser on the user's computing device to create a graphical user interface (GUI).

### Exemplary System and Article of Manufacture Details

The present invention may be a system, a method, and/or a computer program product. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, or either source code or object code written in any combination of one or more programming languages, including an object oriented programming language such as Smalltalk, C++ or the like, and conventional procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

The corresponding structures, materials, acts, and equivalents of all means or step plus function elements in the claims below are intended to include any structure, material, or act for performing the function in combination with other claimed elements as specifically claimed. The description of the present invention has been presented for purposes of illustration and description, but is not intended to be exhaustive or limited to the invention in the form disclosed. Many modifications and variations will be apparent to those of ordinary skill in the art without departing from the scope and spirit of the invention. The embodiment was chosen and described in order to best explain the principles of the invention and the practical application, and to enable others of ordinary skill in the art to understand the invention for various embodiments with various modifications as are suited to the particular use contemplated.

What is claimed is:

1. A method to allocate computing resources among computing tasks, said method comprising:
building a model of benefit of each of said computing tasks under uncertainty as a function of computing resources invested in each of said computing tasks;
building a model of risk of each of said computing tasks under uncertainty as a function of said computing resources invested in each of said computing tasks;
calculating risk of a task allocation with said risk model;
calculating benefit of a task allocation with said benefit model;
finding an allocation of said computing resources to increase said benefit and manage said risk; and
applying said allocation of computing resources to said computing tasks.

2. The method of claim 1, wherein said model building and calculating steps are carried out for a single point in time.

3. The method of claim 1, wherein said model building and calculating steps are carried out over time and weighted according to a preference profile.

4. The method of claim 3, wherein said step of finding said allocation comprises using a stochastic program.

5. The method of claim 3, wherein said benefit comprises mean revenue.

6. The method of claim 3, wherein said benefit comprises a function of mean revenue.

7. The method of claim 3, wherein said benefit comprises a probability of revenue exceeding a certain value.

8. The method of claim 3, wherein said risk comprises value-at-risk.

9. The method of claim 3, wherein said risk comprises conditional value at risk.

10. The method of claim 1, wherein said computing resources comprise cloud computing resources, said computing tasks comprise cloud computing tasks, and said applying step comprises controlling allocation of said cloud computing resources with a cloud management layer.

11. The method of claim 1, wherein said computing resources comprise cybersecurity computing resources, said computing tasks comprise cybersecurity computing tasks, and said applying step comprises controlling installation of a plurality of cybersecurity software packages on a subset of a set of managed computing devices.

12. A non-transitory computer readable medium comprising computer executable instructions which when executed by a computer cause the computer to perform a method to allocate computing resources among computing tasks, said method comprising:
building a model of benefit of each of said computing tasks under uncertainty as a function of computing resources invested in each of said computing tasks;
building a model of risk of each of said computing tasks under uncertainty as a function of said computing resources invested in each of said computing tasks;
calculating risk of a task allocation with said risk model;
calculating benefit of a task allocation with said benefit model;
finding an allocation of said computing resources to increase said benefit and manage said risk; and
applying said allocation of computing resources to said computing tasks.

13. The non-transitory computer readable medium of claim 12, wherein said model building and calculating steps of said method are carried out for a single point in time.

14. The non-transitory computer readable medium of claim 12, wherein said model building and calculating steps of said method are carried out over time and weighted according to a preference profile.

15. The non-transitory computer readable medium of claim 14, wherein said method step of finding said allocation comprises using a stochastic program.

16. The non-transitory computer readable medium of claim 14, wherein said risk comprises value-at-risk.

17. An apparatus for allocating computing resources among computing tasks, said apparatus comprising:
a memory;
at least one processor, coupled to said memory; and
a non-transitory computer readable medium comprising computer executable instructions which when loaded into said memory configure said at least one processor to:
build a model of benefit of each of said computing tasks under uncertainty as a function of computing resources invested in each of said computing tasks;
build a model of risk of each of said computing tasks under uncertainty as a function of said computing resources invested in each of said computing tasks;
calculate risk of a task allocation with said risk model;
calculate benefit of a task allocation with said benefit model;
find an allocation of said computing resources to increase said benefit and manage said risk; and
apply said allocation of computing resources to said computing tasks.

18. The apparatus of claim 17, wherein said model building and calculating are carried out for a single point in time.

19. The apparatus of claim 17, wherein said model building and calculating are carried out over time and weighted according to a preference profile.

20. The apparatus of claim 19, wherein said computer executable instructions which configure said processor to find said allocation comprise a stochastic program.
